(19) United States
(12) Patent Application Publication
(10) Pub. No.: US 2008/0251153 A1
(43) Pub. Date: Oct. 16, 2008

(54) Liquid dispensing system

(76) Inventors: D. Stewart Bell, Arcadia, CA (US); Jeffery Oren Brown, North Logan, UT (US)

Correspondence Address: THORPE NORTH & WESTERN, LLP., P.O. Box 1219, SANDY, UT, 84091-1219, US

(21) Appl. No.: 12/079,952

(22) Filed: Mar. 28, 2008

Related U.S. Application Data
(60) Provisional application No. 60/921,117, filed on Mar. 29, 2007.
(60) Provisional application No. 61/033,768, filed on Mar. 4, 2008.

(51) Int. Cl. B65B 3/24; B67D 5/08; B67D 5/00

(52) U.S. Cl. 141/198; 222/52; 222/39; 222/1

(57) ABSTRACT

The present invention is directed to a liquid dispensing system having a valve subsystem and pumping subsystem. The valve subsystem is configured with a pressure sensor subassembly having an electronic interface to determine the liquid level in a vehicle gasoline tank or other liquid vessel. The valve subassembly of the present invention may include a piezoelectric subassembly to detect pressure changes at a nozzle subassembly to shut off the liquid flow through the valve subsystem and from the pump subsystem. Aspects of the present invention may also sense when the nozzle subassembly has been partially removed from a liquid tank fill tube. The present invention may include wireless technology to transmit information from the valve subsystem to the pump subsystem to prevent an overfill condition in the vessel. For example, the pump subsystem will not pump without confirmatory signal from valve subassembly that all components are operating properly.

The present application claims priority to U.S. Provisional Application No. 60/921,117 filed on Mar. 29, 2007 and U.S. Provisional Application No. 61/033,768 filed on Mar. 4, 2008 each of which are incorporated herein by reference in their entirety.

### BACKGROUND OF THE INVENTION

This invention relates to an improved liquid dispensing system, and more particularly to fuel pump, valve and nozzle assemblies configured for eliminating topping off and overfill of a gasoline or diesel tank.

Due to the seriousness of smog in Southern California, the Air Quality Management District (AQMD) Board has adopted progressively stricter regulations dealing with sources of smog. AQMD considers so-called “five percent” contributors to be important, as several of these add up to serious pollution. For this reason, AQMD has regulations covering lawn mowers and barbeque lighter fluids—both comparatively small contributors to smog. Much of the automotive gasoline and diesel fuel sold is through self-service pumps. When motorists fill their car's gasoline tanks, they often keep filling them after the hose clicks off, to get the tank as full as possible. The current device that is used to prevent “topping off” is composed of technology that is typically outdated, being twenty-five to fifty years old. The pump dispenses a little gasoline each time the motorist clicks the handle, before it senses the tank is already full. So motorists continue to keep clicking the pump on repeatedly to coax in extra gasoline. When tanks are overfilled in this way, gasoline is often spilled out and evaporative recovery systems can be damaged, causing increased smog emissions.

Such unburned gasoline vaporizes and contributes directly to smog far more than it would if it were burned in the engine and the exhaust passed through a catalytic converter. The State of California has tried to deal with this—it is against the law to top off a tank. There are signs prohibiting it at each gasoline pump and fines are posted for the practice, but in reality it is probably impossible to stop the practice, despite attempts to educate the ten million California motorists, and the many out of state drivers.

Chemical Problems from Gasoline

### Environmental Impact

Hydrocarbon and other Organic Compounds

Toxic Chemicals

Produces Vapors

Produces Smog

Produce Ozone

### Toxic Substances in Gasoline:

Benzene

Primary Toxic Air Pollutant to Public Health

Carcinogen—Linked to leukemia and other cancers

### Affects:

Central Nervous System

Respiratory Tract-Asthma

Immune System

Toluene

Developmental Toxicant

Potential to affect fetal development

Central Nervous System Depressant

Associated with:

Cardiac Arrhythmias

Liver & Kidney Injury

### Sources of Spillage

### Deliberate Topping-Off

Spillage from current customer

Excess in hose from previous customer

### Unintentional Overfilling

Problems of mechanical shut-off

Spilling, splashing, or being spit back

Mechanical failure

Filling tube speed increase

Dripping from Nozzle

### “Top-Off” Problem

Common for customers to re-click nozzle and “top-off” Tank

Customers want more fuel or even dollar amount

Valve is reset, but no time system to react

Fuel spills on ground

Fuel backs-up in filling tube

Fuel spills for next customer

Warm weather—fuel expands after tank is filled

### “Filling Tube” Problem

Difference in Volume

Fuel tank much larger than fill tube

Fuel level speeds-up at top of fill tube

Turbulence results in fuel vapors being released from fill tube

Fuel splashes out of fill tube

### Mechanical Valves Too Slow

Fuel spills out

Old technology in nozzle inadequate to solve problem

Accordingly, what has been needed and heretofore unavailable is an improved fuel valve system that overcomes the deficiencies of existing fuel valve configurations so as to eliminate the problem of intentional gasoline top-offs and overfilling of gasoline tanks. The present invention disclosed herein satisfies these and other needs.

### SUMMARY OF THE INVENTION

The present invention is directed to a system that can effectively eliminate the problem of intentional gasoline or other fuel top-offs, thereby effectively providing a significant contribution to national health and environmental problems related to fueling automobiles at gas stations. In one embodiment, the present invention uses an electronic (for example, piezoelectric) pressure sensor with electronic and mechanical actuator subassemblies in a fluid (for example, gasoline or other fuel) valve assembly (dispenser) to determine the liquid level in a vessel (for example, in the fill tube of an automobile gasoline tank). Current gasoline dispensing fuel valve assemblies use a mechanical system to detect pressure changes at the nozzle tip to shut off the fluid flow through the fuel valve assembly to the nozzle subassembly. In those assemblies, fluid (gasoline) flow shutdown is actuated by a pressure differential on either side of a diaphragm that is positioned between two chambers in the main body of the fuel valve assembly. The pressure in the gasoline tank fill tube is communicated from the nozzle tip via a small lumen tube connected to a chamber on one side of the diaphragm.

In one embodiment of the present invention, the pressure sensing electronics in the fuel valve assembly sense the pressure change in the fill tube as the fluid reaches the nozzle tip. The electronic and mechanical actuator subassemblies of the present invention work with the existing mechanical systems in the fuel valve assembly to stop fluid flow through the nozzle. The present invention is configured to avoid placing electronics at the nozzle tip where it can be exposed to an inflammable such as gasoline and other fuels. In one aspect, the present invention may also include using wireless or other suitable technologies to transmit information from the fuel valve assembly to the pump electronics to shut off the pump to prevent an overfill condition for example (i.e., to prevent a motorist from re-clicking to top-off after the nozzle has shut off).

The present invention is further directed to a multi-component fuel valve system that will improve gasoline (or other fuel) pumps by eliminating the topping off of gasoline tanks. The technologies used in the present invention may allow much faster filling of motor vehicles. The technology of the present invention can be used for, but is not limited to, filling of fuel tanks for motor vehicles, trains and airplanes. The system of the present invention may incorporate known and mainstream technologies such as electrical, optical and mechanical sensors, and may incorporate yet to be developed devices that include nanotechnology materials or other cutting edge technologies. Examples of devices that may be used in or with the system of the present invention include, but are not limited to, U.S. patent and Publication Nos. 4,274,705; 4,641,025; 5,588,558; 5,712,934; 5,867,403; 6,049,088; 6,333,512; 6,363,784; 2004/0021,100 and 2004/0079,149; which are incorporated herein in their entirety by reference.

One aspect of the system of the present invention is a position sensor—for example, pressure sensors, distance probes, fuel vapor detection systems, collar (bellows) spring detection systems, laser or other electronic device—that may be located at the portion of the nozzle to be inserted into a receptacle (fill tube) for the fuel tank. Unless the position sensor indicated that the nozzle was fully inserted into the tank, the system of the present invention would not allow gasoline or other fuel to be pumped. In one aspect of the invention, multiple position sensors may be used with the present invention to enhance the system. Accordingly, the system may be configured to prevent motorists from withdrawing the nozzle partway out of the filling tube in an attempt to circumvent other anti-overfill features of the gasoline pump. In particular, the system of the present invention would be configured to terminate the flow of fuel to the nozzle when one or more of the sensors indicate that the nozzle is incorrectly positioned. So configured, the system would prevent motorists from pulling the nozzle further and further out of the tank when the tank is full, so as to overfill the tank. In one aspect of the present invention, a bypass switch, under control of a gas station attendant, could be incorporated into the system of the present invention to inactivate the position sensor to allow filling of an unusual receptacle (lawn mower, gas can, etc.) so as to fill it with gasoline.

In one embodiment of the present invention, sensors (e.g., watchdog circuitry) is used to detect if components of the system are malfunctioning. During filling of fuel tanks, if electronics within the system are malfunctioning or if the power source (e.g., batteries) are low, fuel flow through the system is precluded. In one aspect fueling sequences may not even begin if the system is malfunctioning. In another aspect, fueling sequences are terminated if the system is malfunctioning. Advantageously, due to the increased sensitivity of electronic shutoff, aspects of the present invention allow for faster fuel or liquid flow without the increased risk of significant fuel spillage from malfunctioning shut off components.

It is to be understood that the present invention is not limited by the configurations of the fuel valve described herein or by the materials of construction disclosed. The inventive concept may also be extended beyond conventional fuel dispensers. Other features and advantages of the present invention will become more apparent from the following detailed description of the invention, when taken in conjunction with the accompanying exemplary drawings.

### BRIEF DESCRIPTION OF THE DRAWINGS

FIG. 1 is an exploded perspective view of a fuel valve assembly according to one embodiment of the present invention;

FIG. 2 includes top and bottom perspective views of a main body subassembly, a nozzle subassembly and a cover subassembly according to one embodiment of the present invention;

FIG. 3 includes top left, top right-bottom left and bottom right perspective views of a cover subassembly according to one embodiment of the present invention;

FIG. 4 includes perspective and cross-sectional views of a cover subassembly according to one embodiment of the present invention;

FIG. 5 is an exploded perspective view of a pressure sensor subassembly according to one embodiment of the present invention;

FIG. 6 is an exploded perspective view of a main body subassembly, portions of a pressure sensor subassembly, portions of a solenoid subassembly and portions of an actuator subassembly according to one embodiment of the present invention;

FIG. 7 includes top and bottom perspective views of a solenoid subassembly according to one embodiment of the present invention;

FIG. 8 is an exploded perspective view of a solenoid subassembly according to one embodiment of the present invention;

FIG. 9 is an exploded perspective view of an actuator subassembly according to one embodiment of the present invention;

FIG. 10 includes top and bottom perspective views and an exploded perspective view of a roller bracket of an actuator subassembly according to one embodiment of the present invention;

FIG. 11 includes top and bottom perspective views of portions of an actuator subassembly disposed in the housing of a main body subassembly of a fuel valve assembly according to one embodiment of the present invention;

FIG. 12 is a side perspective view depicting a solar cell subassembly and light source subassembly adapted for use with a fuel valve assembly according to one embodiment of the present invention;

FIG. 13 is an exploded perspective view of a solar cell subassembly according to one embodiment of the present invention;

FIG. 14 is an exploded perspective view of a light source subassembly adapted for use with a solar cell subassembly according to one embodiment of the present invention;

FIG. 15 is a partial perspective view of a solar cell subassembly and light source positioned in a gasoline pump according to one embodiment of the present invention;

FIG. 16 is a top perspective view depicting a fuel valve assembly having a pressure strip detection system in the nozzle subassembly according to one embodiment of the present invention;

FIG. 17 is a top perspective view depicting a fuel valve assembly having a collar spring detection system positioned at the nozzle subassembly according to one embodiment of the present invention;

FIG. 18 is a top perspective view depicting a fuel valve assembly having a fuel vapor detection system positioned at the nozzle subassembly according to one embodiment of the present invention;

FIG. 19 is a schematic representation depicting a radio frequency transmitter subassembly configured in a fuel valve assembly and a radio frequency receiver subassembly configured in a fuel pump according to one embodiment of the present invention;

FIG. 20 is a schematic representation depicting an infrared transmitter subassembly configured in a fuel valve assembly and an infrared receiver subassembly configured in a fuel pump according to one embodiment of the present invention;

FIG. 21 is a schematic representation depicting an ultrasonic transmitter subassembly configured in a fuel valve assembly and an ultrasonic receiver subassembly configured in a fuel pump according to one embodiment of the present invention;

FIG. 22 depicts an electrical schematic of one embodiment of a connector board according to one embodiment of the present invention;

FIG. 23 depicts an electrical schematic of one embodiment of a solenoid board according to the present invention;

FIG. 24 is a side view of an actuator subassembly according to one embodiment of the present invention; and

FIG. 25 is a perspective view of an actuator subassembly according to one embodiment of the present invention.

### DETAILED DESCRIPTION OF THE PREFERRED EMBODIMENTS

The present invention is directed to a fuel valve assembly having an improved pressure sensor configuration. The fuel valve of the present invention includes a reliable liquid sensor that can effectively eliminate the problem of intentional gasoline top-off's—effectively providing a significant contribution to national health and environmental problems related to fueling cars at gas stations. It should be appreciated that the embodiments of the fuel valve assembly described herein are illustrated and described by way of example only and not by way of limitation. Also, while the present invention is described in detail as applied to a pressure sensor with an electronic interface to determine the liquid level in an automobile gas tank, those skilled in the art will appreciate that it can also be used in other vessels, such as trucks, trains, ships, farm vehicles and aircraft. Additionally, the present invention can be utilized in nonmoving vessels, such as storage tanks and mixing vessels.

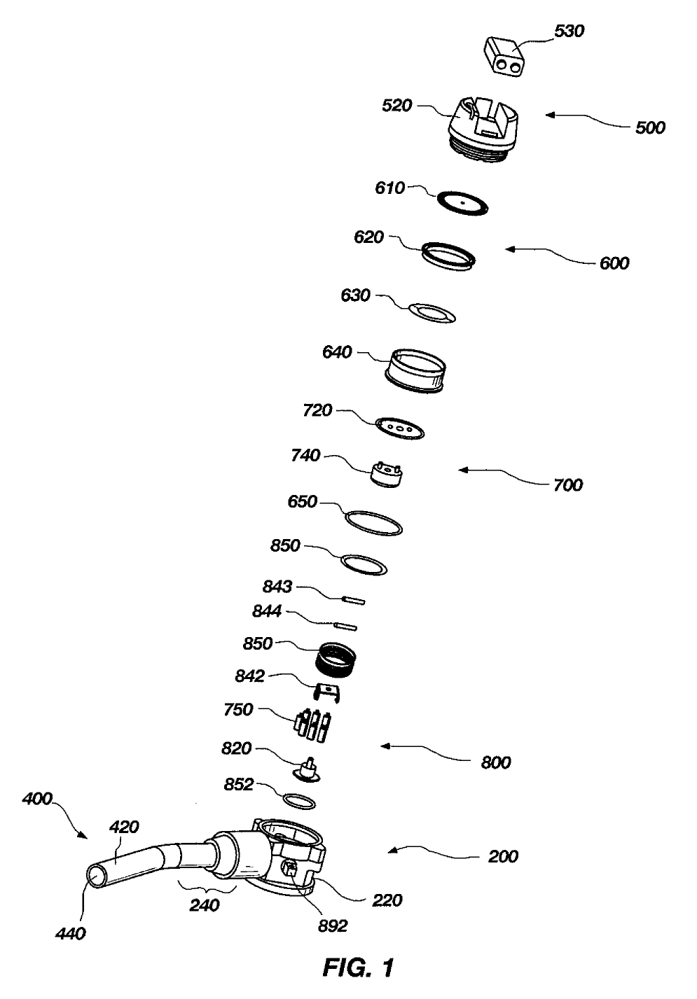

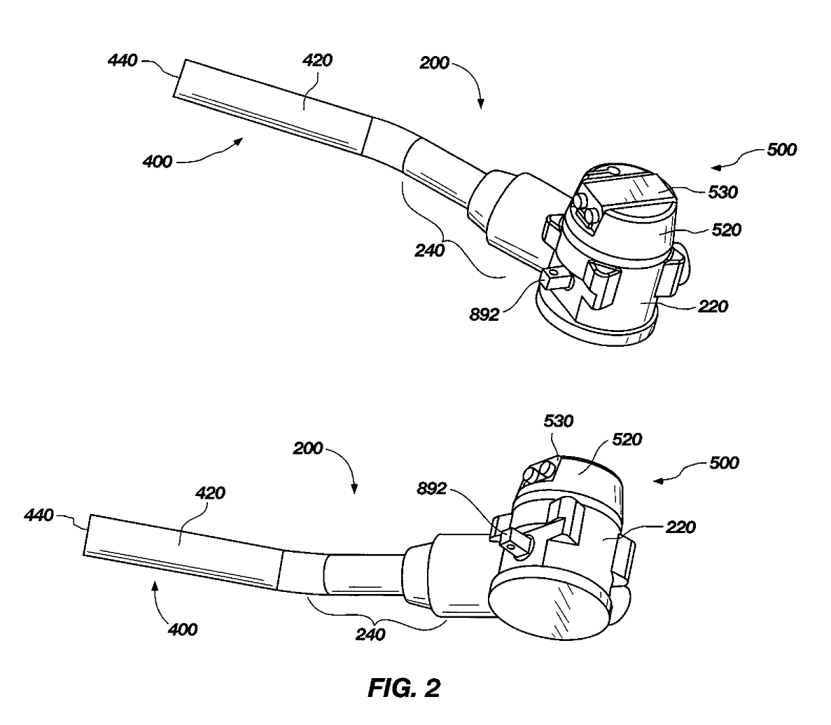

Turning now to the drawings, in which like reference numerals represent like or corresponding elements in the drawings, FIGS. 1 and 2 illustrate one embodiment of a fuel valve assembly 100 of the present invention. The fuel valve includes a main body subassembly 200 having a handle subassembly 300 and a nozzle subassembly 400. The fuel valve assembly further includes a cover subassembly 500, a pressure sensor subassembly 600, a solenoid subassembly 700, a capacitor subassembly 800 and an actuator subassembly 900.

The main body subassembly 200 of the fuel valve 100 of the present invention includes a parts housing 220 and connector system 240 that may be configured from presently available fuel valves, such as those from Emco Wheaton Corporation of Oakville, Canada, NC; Emco Wheaton Retail Corporation of Wilson, N.C., OPW Fueling Components of Cincinnati. Ohio; and Healy Systems, Inc of Hudson, N.H. Likewise, the handle subassembly 300 may be configured from mechanisms available from the manufacturers of the main body subassembly or may be customized for the present application as would be understood by those of ordinary skill in the art.

The nozzle subassembly 400 is attached to the connector system 240 of the main body subassembly 200, and may also be configured from presently available systems or may be customized for the present invention. The nozzle subassembly may include a main tubular body 420 having an end orifice 440. At the orifice, the inside of the main tubular body includes a small orifice or venturi port 462 connected to a hollow conduit 460 for creating a pressure differential used by the pressure sensor subassembly 600.

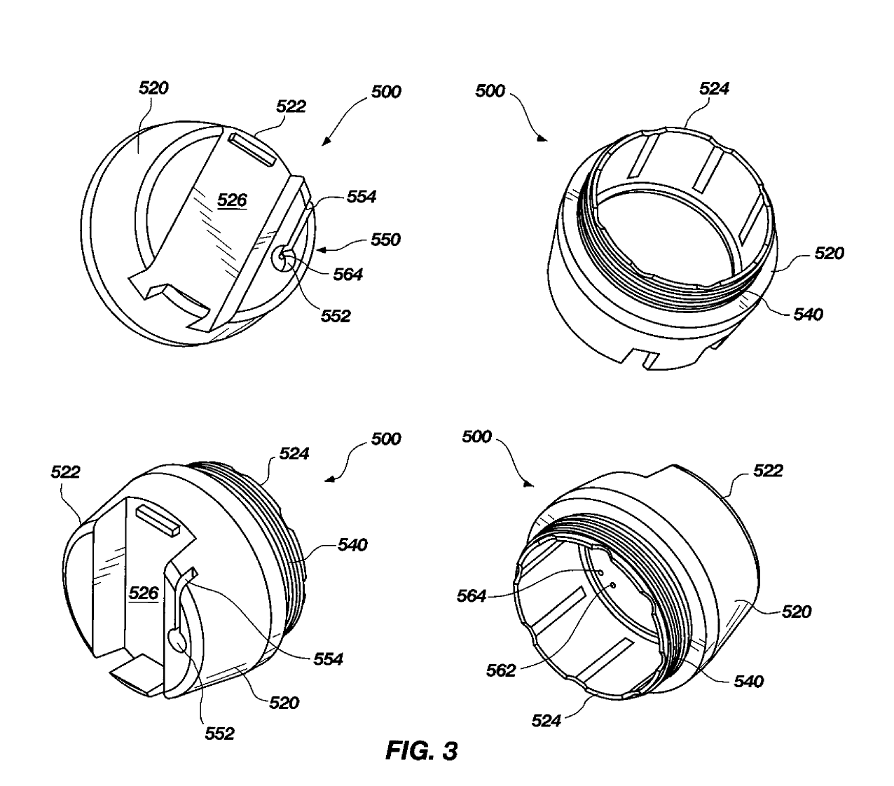

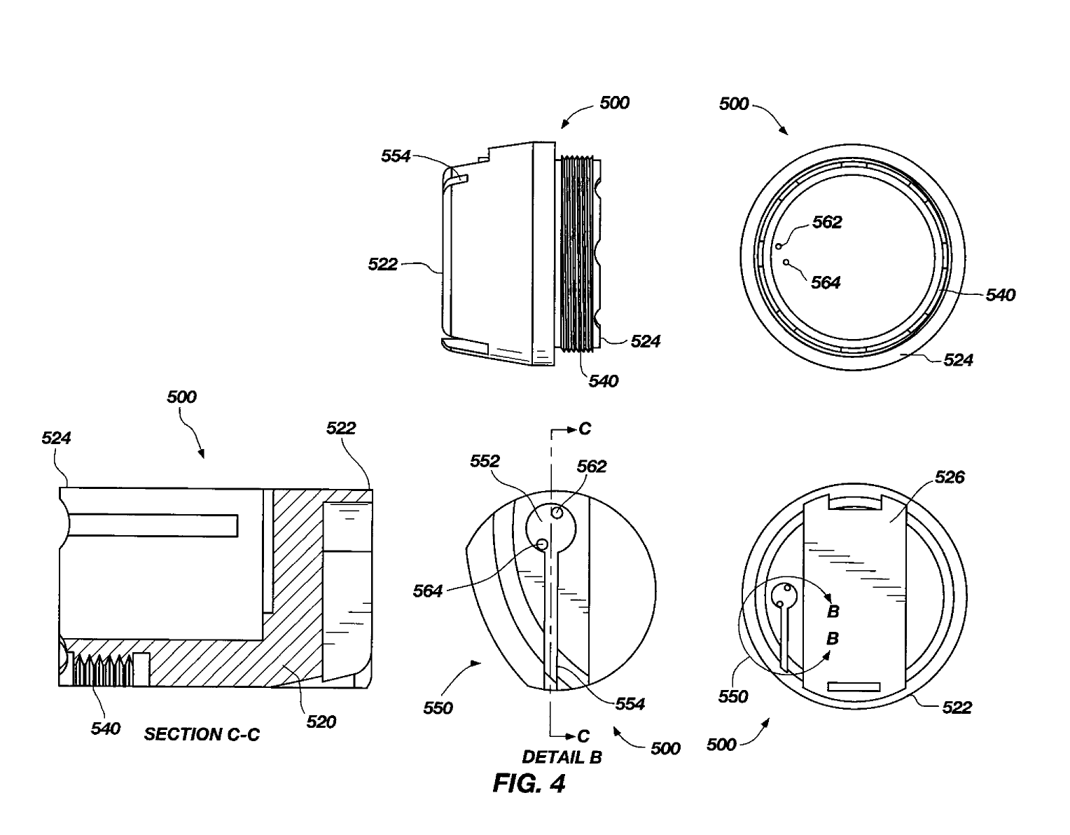

Referring specifically now to FIGS. 3 and 4, the cover subassembly 500 of the fuel valve 100 includes a main body 520 having an upper portion 522 and a lower portion 524. The upper portion of the cap assembly may be configured with a groove or cutout 526 for housing a battery 530 or other power source, such as a solar cell, fuel cell or other energy source. The lower portion of the cap assembly may be configured with a threaded section 540 or other locking mechanism as would be known to those of ordinary skill in the art, such as a tongue and groove system. The cap may be further configured with an aperture or relief cut 550 having a circular portion 552 and a linear portion 554. The purpose of the cap relief cut is to place a sealant around the battery wires to preserve the pressure profiles inside the cap subassembly. The circular portion 552 is connected to two cylinder holes 562, 564 that traverse from the cap subassembly top portion to the bottom portion of the cap subassembly. The purpose of the two cylinder holes is for retaining spring loaded battery contacts and associated wires.

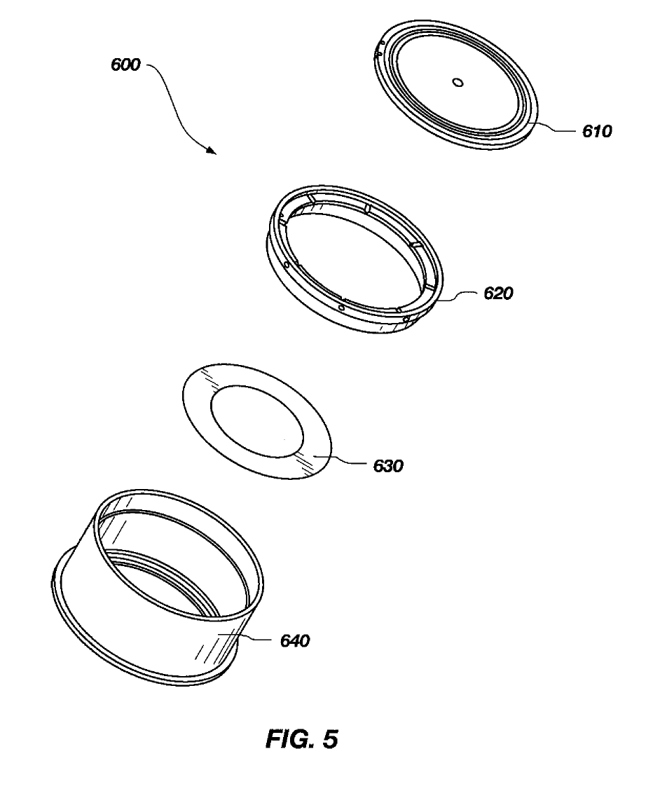

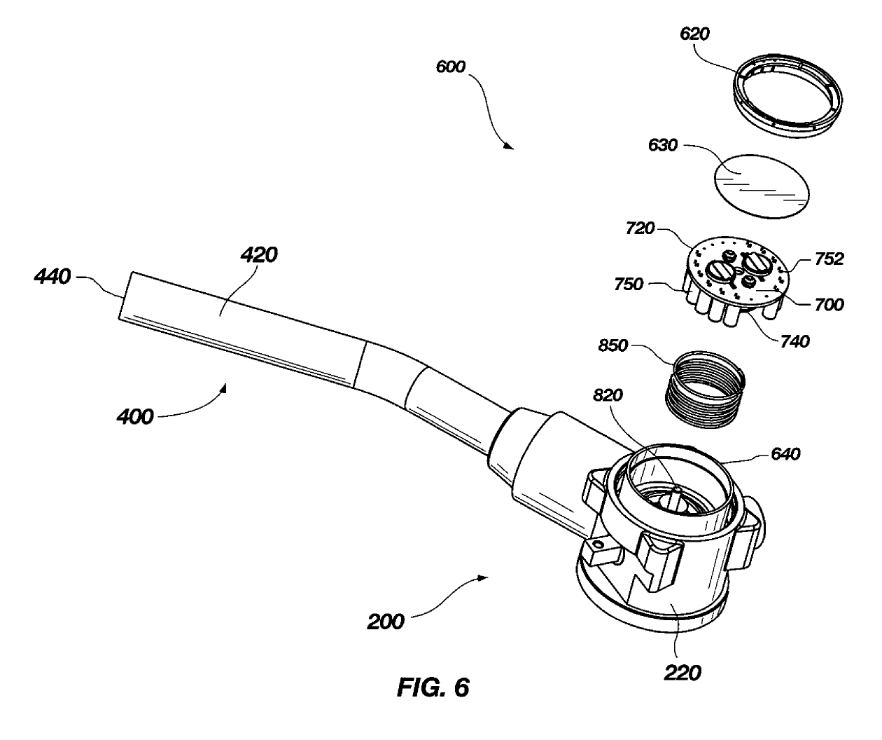

Referring now to FIGS. 5 and 6, the pressure sensor subassembly 600 of the fuel valve 100 assembly of the present invention includes a connector board 610, a cap adaptor 620, a piezoelectric disk 630 and a central housing 640. The connector board provides an electrical connection from the battery 530 or other external power source to the solenoid subassembly 700. The piezoelectric disk 630 provides an electrical switch mechanism so as to activate the solenoid subassembly. An electrical schematic of one embodiment of the connector board is shown in FIG. 22. The cylindrical central housing of the pressure sensor subassembly is connected to the cover subassembly 500 via the toroidal cap adaptor. The cap adaptor is configured to accept the threaded portion 540 or other connecting mechanism of the bottom portion 524 of the cover body 520. The pressure sensor central housing may be provided with a seal, such as an O-ring 650 to prevent fluid leakage between the pressure sensor subassembly, the cover subassembly, and the fuel valve main body 200.

When the piezoelectric disk 630 senses a pressure differential between the two sides of the disk, it passes the electric current provided by the connector plate 610 to the solenoid subassembly 700. In the fuel valve 100 of the present invention, one side of the piezoelectric disk is in a closed environment that is connected to the venturi tube 460. The other side of the piezoelectric disk 630 is open to atmospheric pressure. When the nozzle subassembly 400 is placed into a fuel receiving receptacle (for example, the inlet to an automobile gas tank), the venturi tube 460 provides atmospheric pressure to the piezoelectric disk 630 and there is no pressure differential and no electric current is passed to the solenoid subassembly. When fuel rises to the level of the venturi tube opening 462 in the end orifice 420 of the nozzle 420, then the fuel moving past the venturi tube opening 462 causes a drop in pressure on one side of the piezoelectric disk. Thus, as the fuel rises in an automobile tank to the level of the opening in the nozzle of the fuel valve, an electric current is sent to the solenoid subassembly 700.

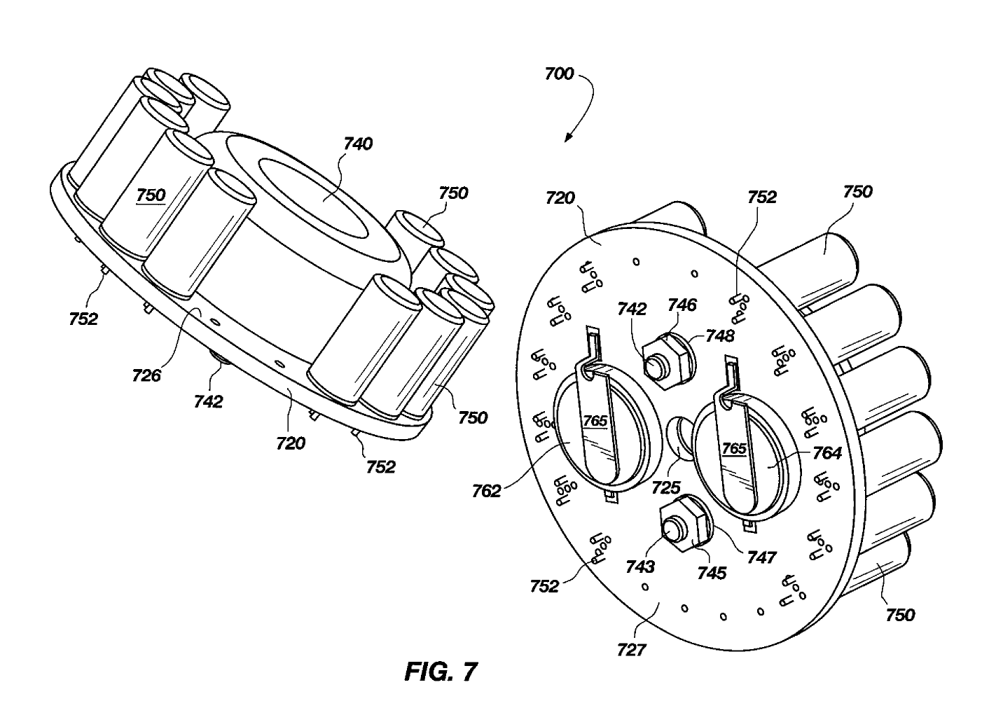

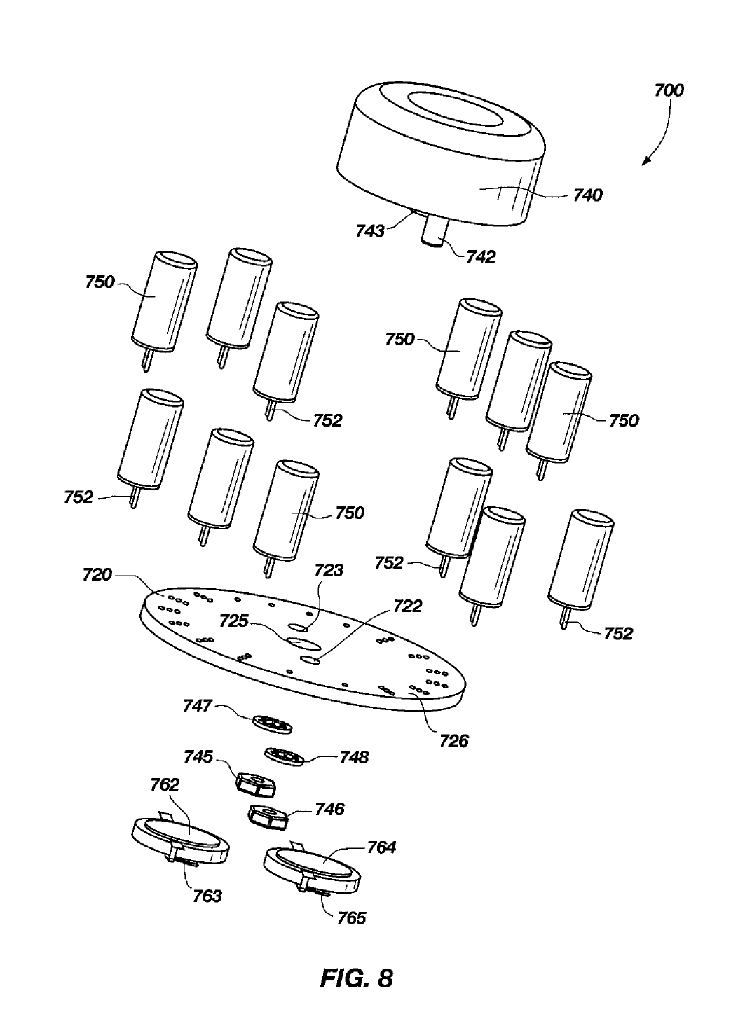

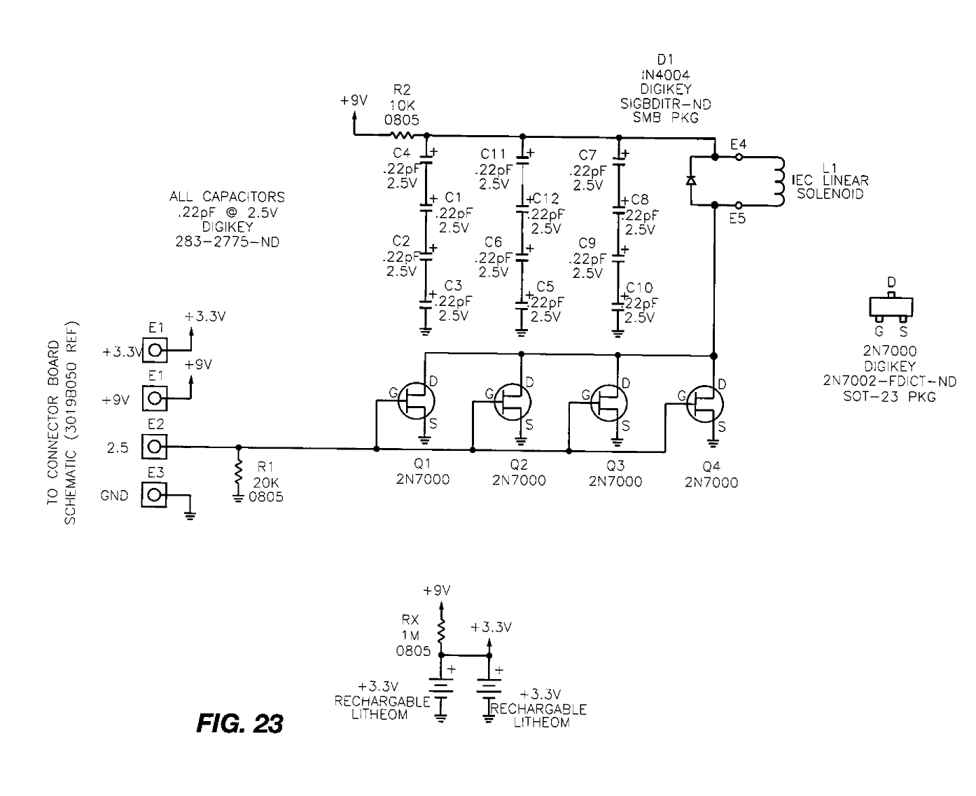

As shown in FIGS. 7 and 8, the solenoid subassembly 700 of the fuel valve 100 of the present invention includes a printed circuit board 720, a solenoid 740 and a plurality of capacitors 750. An electrical schematic of one embodiment of a printed circuit board for the solenoid subassembly is shown in FIG. 23. The printed circuit board may be configured to sense and amplify an electrical signal from the piezoelectric disk 630, and may further include transistors and other components configured to activate the solenoid. The solenoid is mechanically connected to the activation subassembly 800. The solenoid is electrically coupled to the top portion 726 of the circuit board, and includes two prongs 742, 753 that are removably secured within holes 722,723 in the circuit board by pairs of nuts 745, 146 and washers 747, 748 or other suitable mechanisms. Each capacitor includes a pair of electrical connector prongs 752, and is in electrical communication with and resides on the top portion of the circuit board. The solenoid receives its power from the capacitors, which are charged by the external power source (i.e., battery 830, solar cell subassembly 900, etc.) by electrical connection to the connector board 610. The solenoid subassembly further includes one or more back-up batteries (for example, lithium) that are in electrical communication with and are secured to the bottom portion 727 of the circuit board by spring flanges 763, 765 or other suitable mechanisms. The circuit board is further configured with a central bole to accept a plunger 820 driven by the solenoid.

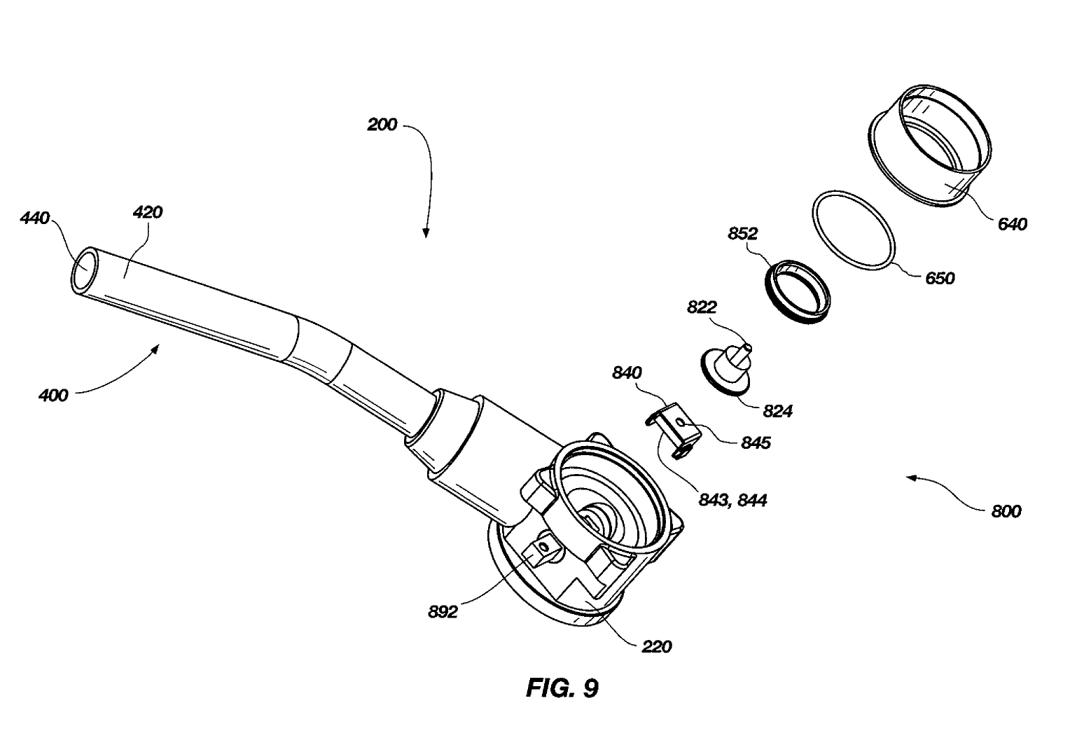

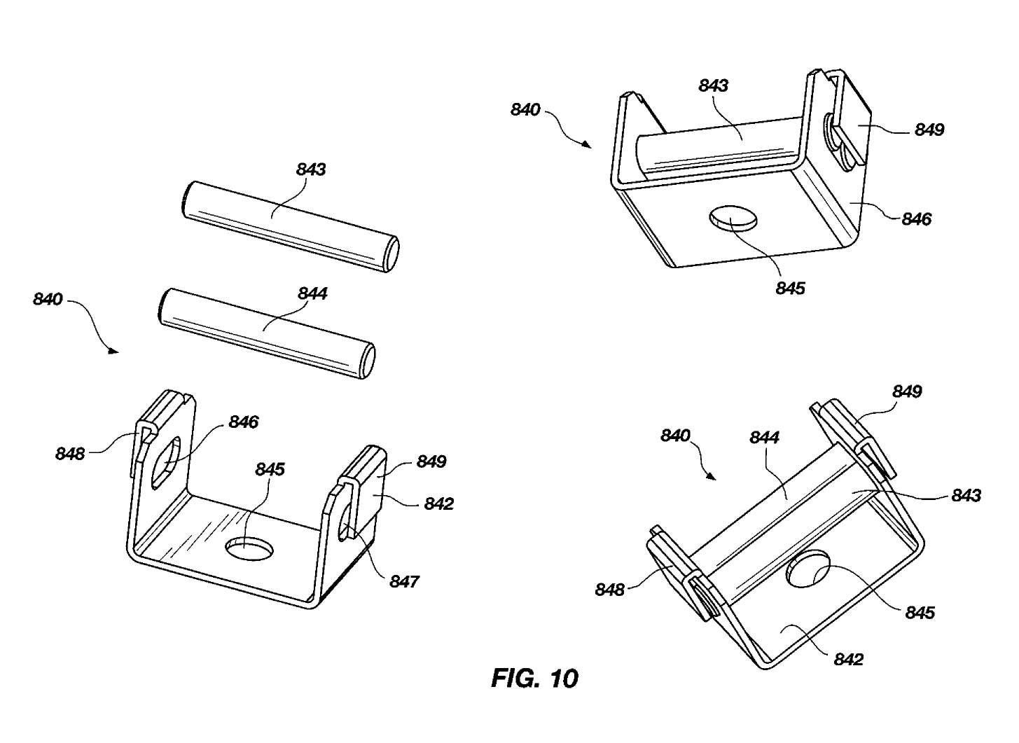

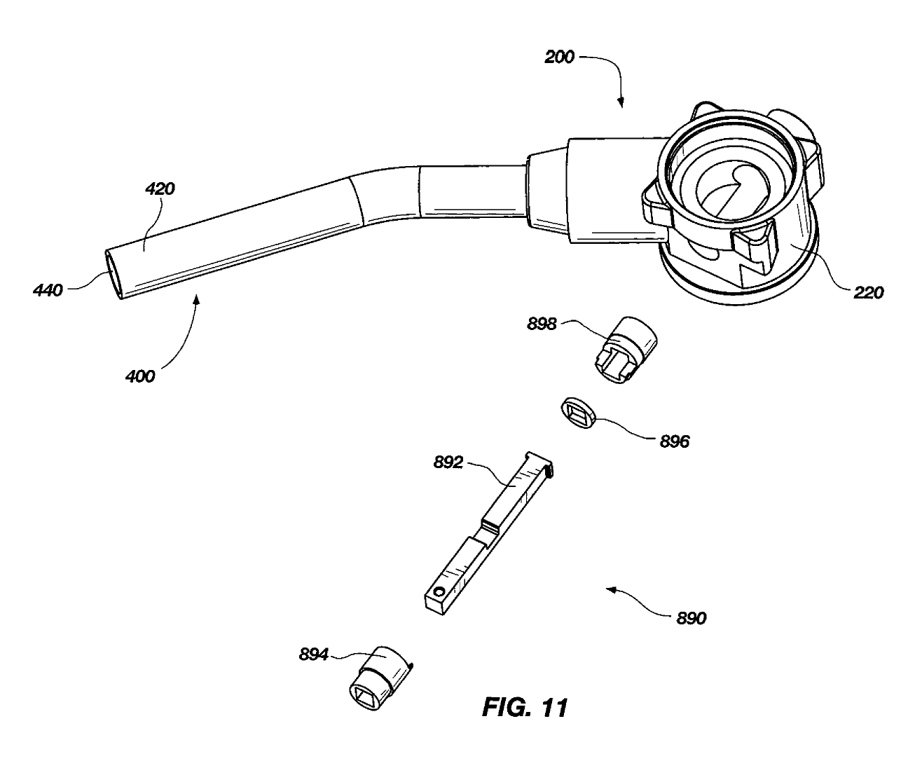

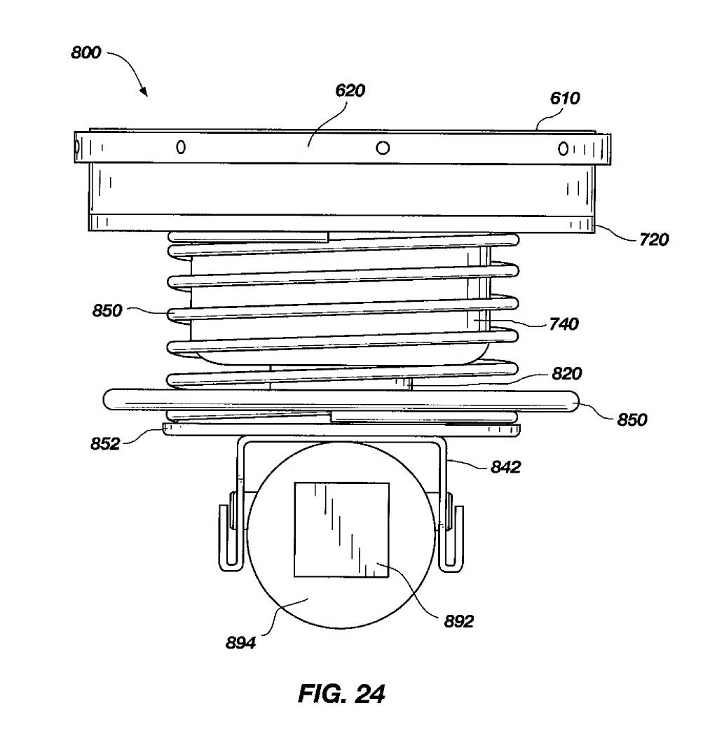

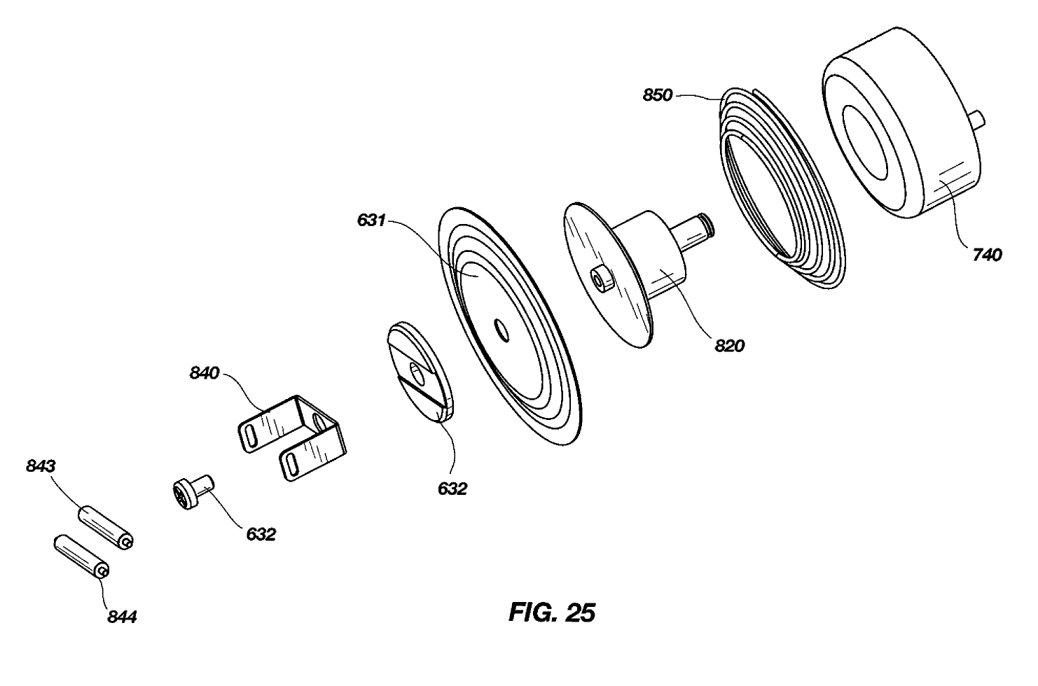

Referring now to FIGS. 9-11 and 24, the actuator subassembly 800 is configured to be disposed within the parts housing 220 of the main body subassembly 200 of the fuel valve assembly 100 of the present invention. The actuator subassembly includes a solenoid plunger 820 operably connected to the solenoid 740. The solenoid plunger may include a cylindrical main body that is configured to be disposed within the central hole 725 of the solenoid circuit board 720. The solenoid plunger may include a cylindrical main body that is configured to be disposed within the central hole 725 of the solenoid circuit board 720. The actuator subassembly further includes a spring ring 852 configured for holding in place the spring or biasing mechanism 850 against disk-shaped bottom portion 824 of the solenoid plunger. The actuator mechanism further includes a roller bracket mechanism 840 configured for releasing a spring-loading rod (for example, a square peg) 892. The roller bracket mechanism includes a U-shaped body 840 and one or more dowels OT Jolters 843, 844. The U-shaped body is formed with a central hole 845 in the main body portion configured for alignment with an upper (for example, cylindrical) flange 822 and the disk-shaped bottom portion of the solenoid plunger. The sides of the roller bracket mechanism further include cutouts 846, 847 and flanges 848, 849 for accepting and retaining the rollers.

The solenoid plunger 820 and roller bracket mechanism 840 are configured to work with an adapter (linear actuator) mechanism 890 including the spring-loading rod 892, a bottom slider 894, a central grommet 896 having a round hole and a top slider 898. The adaptor mechanism is configured to reside within the parts housing 220 of the main body subassembly 200 and to interface with the handle subassembly 300 and the poppet mechanism of the fuel valve assembly to stop the flow of fuel when the piezoelectric disk 630 detects fuel flowing at the orifice 440 at the nozzle subassembly 400.

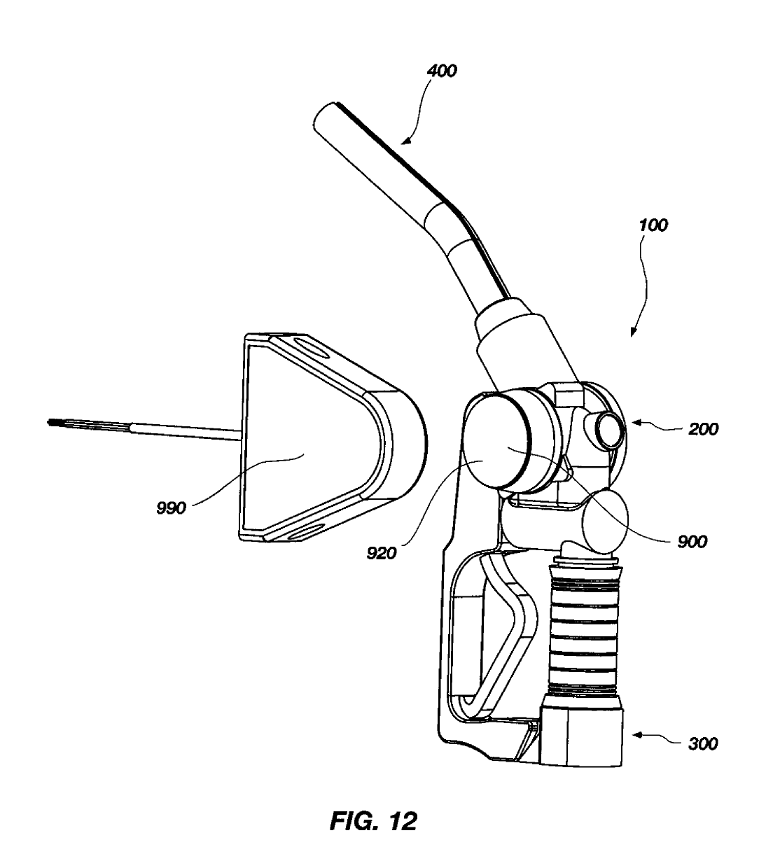

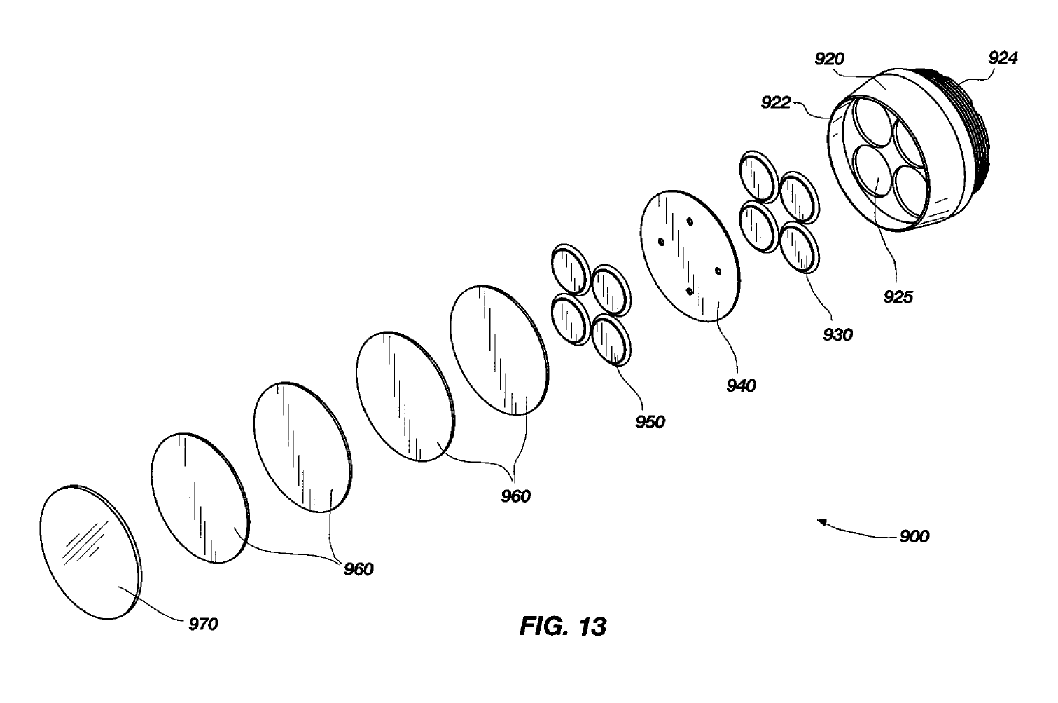

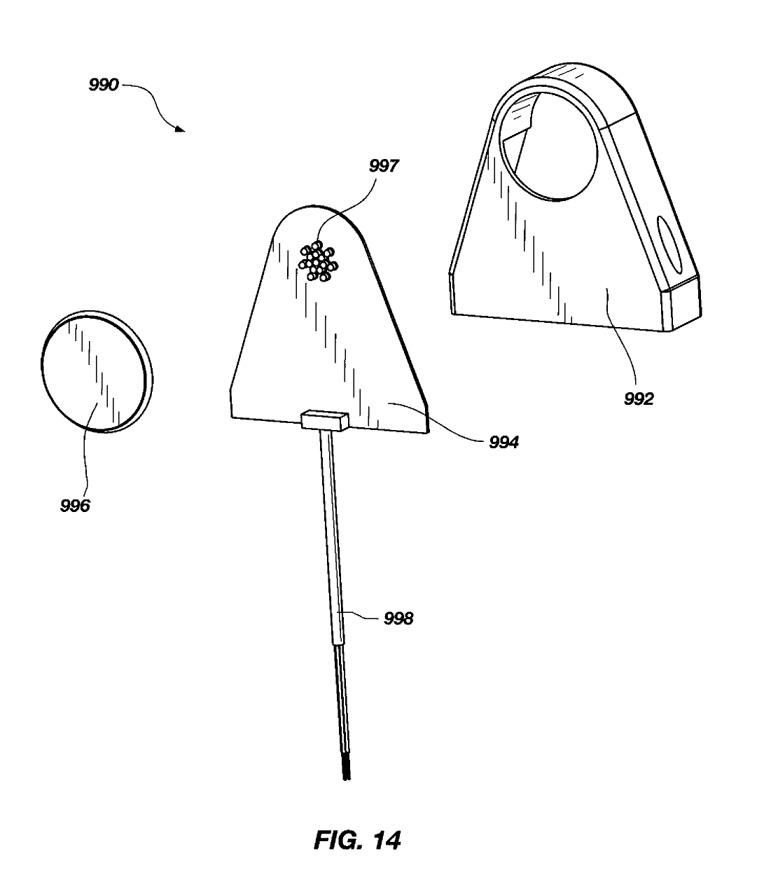

Referring now to FIGS. 12-15, the fuel valve assembly 100 of the present invention may be adapted for use with a solar cell subassembly 900 configured to provide electrical power to the solenoid subassembly 700. In one aspect of the invention, the solar cell subassembly includes a cover or cap 920 having a top light receiving portion 922 and a bottom threaded portion 924 adapted to be removably secured to the parts housing 220 of the main body subassembly 200 of the fuel valve assembly. The solar cell cap inner portion includes receptacles 925 for a plurality of rechargeable batteries 930, 950. The solar cell subassembly further includes a battery board 940 configured to conduct the electric power from the batteries to the solenoid subassembly 700. A plurality of solar cells 960 are stacked or otherwise positioned within the solar cell cap. A light transparent window 970 is secured to the top portion of the solar cell cap.

In one embodiment of the invention, the solar cell subassembly may include an optional light source 990 that may reside in the cradle 1200 of the pump subsystem 1000. The light source is positioned to illuminate the light transparent window 970 secured to the top portion of the solar cell cap 920. The light source may be configured with a main housing 992, a receiver board assembly 994 and a lens 996. The receiver board assembly may be configured with a plurality of light emitting diodes 997 or other light source and a power conduit 998. The light transparent window 970 is secured to the top portion of the solar cell cap window may be configured for use with the light source. In one aspect, the light source may be positioned within a cradle 1200 of the pump subsystem 1000. In an additional aspect, the fuel valve assembly 100 further comprises an audible or visual indicator (not shown) configured to indicate when the power reserve of the power source drops below a predetermined level.

In yet another embodiment, the fuel valve assembly 100 of the present invention may be adapted for use with a rechargeable battery 930, 950 configured to provide electrical power to the solenoid subassembly 700. The power conduit 998 may be configured to connect to a contact member disposed on a portion of the fuel valve assembly 100 when docked within the cradle 1200. In another aspect, the power conduit 998 may be configured to recharge the batteries 930 through use of a suitable induction coil/induction core arrangement like that described in U.S. Pat. No. 7,180,265 which incorporated herein by reference in its entirety.

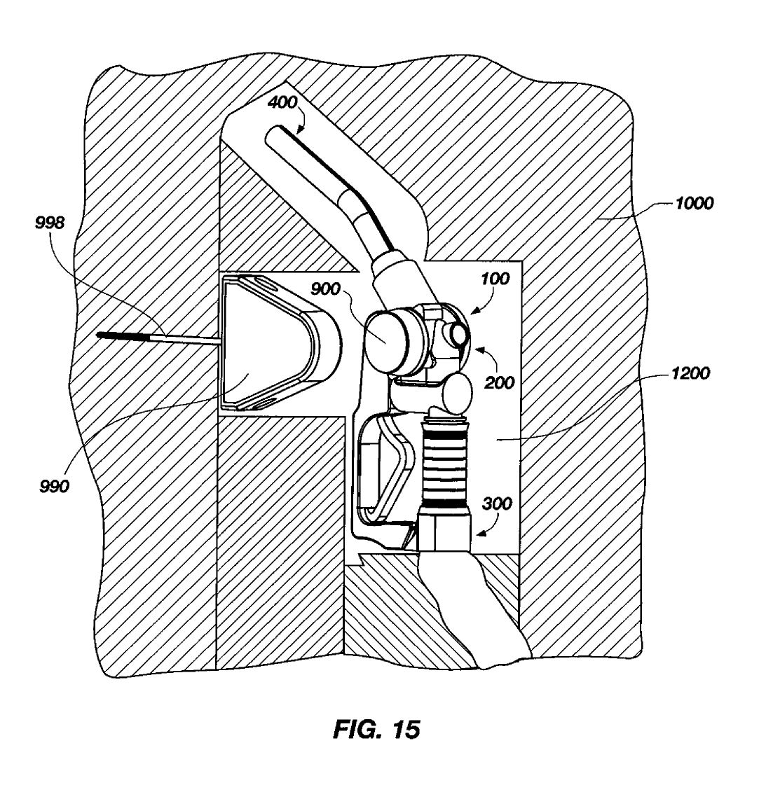

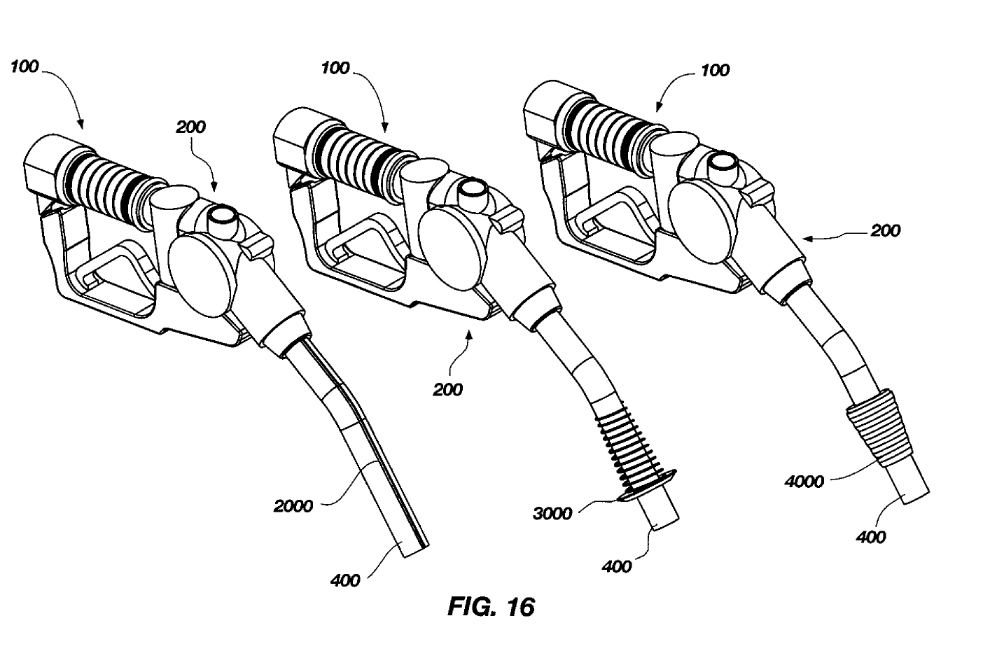

Referring now to FIGS. 16-18, the liquid dispensing system of the present invention may include a position detection system that may be located at the end of or within the nozzle subassembly 400 of the fuel valve assembly 100 to be inserted into a receptacle (fill tube) for the fuel tank. For example, a pressure strip sensor detection system 2000, a collar (bellows) spring detection system 3000, a fuel vapor detection system 4000, or a distance probe such as laser or other electronic device (not shown) may be configured to indicate whether the nozzle subassembly is fully inserted into the tank. According to one aspect of the system of the present invention, the pump subsystem 1000 would include a cutoff subassembly (not shown) that would not allow gasoline or other fuel to be pumped to the fuel valve assembly. The light source power conduit 998 may be connected to the main electrical supply (not shown) of the pump subsystem.

As will be appreciated by those of ordinary skill in the art, multiple position sensors may be used with the present invention to enhance the system. Accordingly, the system may be configured to prevent motorists from withdrawing the nozzle partway out of the filling tube in an attempt to circumvent other anti-overfill features of the gasoline pump. In particular, the system of the present invention may be configured to terminate the flow of fuel to the nozzle when one or more of the sensors indicates that the nozzle is incorrectly positioned. So configured, the system would prevent motorists from pulling the nozzle further and further out of the tank when the tank is full, so as to overfill the tank. A bypass switch, under control of a gas station attendant, could be incorporated into the system of the present invention to inactivate the position sensor to allow filling of an unusual receptacle (lawn mower, gas can, etc.) so as to fill it with gasoline.

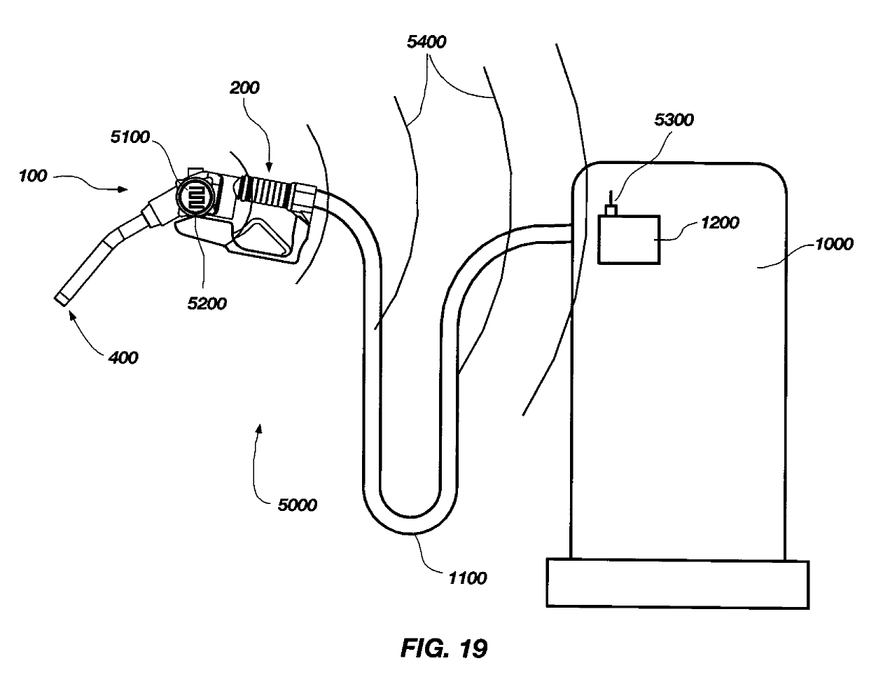

Referring now to FIGS. 19-21, the liquid dispensing system of the present invention includes a pump subsystem 1000 having a hose subassembly 1100 connected to the main body (parts housing) 200 of the fuel valve assembly 100. The pump subsystem further includes a cutoff subassembly 1200 that is used to turn off an internal liquid pump during emergency or other preconfigured conditions. The present invention contemplates an interface between the cutoff subassembly and the fuel valve assembly, such that when the pressure sensor subassembly 600 detects an overfill condition, a signal is sent to the cutoff subassembly to cease flow of gasoline or other fuel to the fuel valve assembly 100. Similarly, the system may be configured to activate the cutoff subassembly 1200 when a position detection system indicates that the nozzle subassembly 400 is not properly positioned within the fill tube of the fuel tank. Advantageously, when a consumer attempts to back the nozzle subassembly from the fill tube of the fuel tank to “top-off” the gasoline tank, the position detection system would automatically terminate fluid flow via the cutoff subassembly 1200 and/or automatic actuation of the solenoid subassembly 700. In one aspect of the invention, the main body subassembly 200 would have to be re-docked with the cradle 1200 of the pump subsystem to reinitiate the pumping sequence. In another embodiment, a bypass switch operated by a service station owner could be used to reinitiate the pumping sequence.

Referring generally to FIG. 19, a radio frequency (RF) subassembly may be configured to transmit a signal from the pressure sensor subassembly 600 using a radio frequency transmitter subassembly 5100 and a sending antenna subassembly 5200. The pump subsystem 1100 may be configured with a receiving antenna subassembly 5300 operably connected to the cutoff subassembly 1200. The cutoff subassembly may be configured to cease flow of liquid to the fuel valve assembly 100 when it receives a signal from the receiving antenna subassembly generated by the sending antenna subassembly and transmitted from the fuel valve assembly 100 via radio waves 5400.

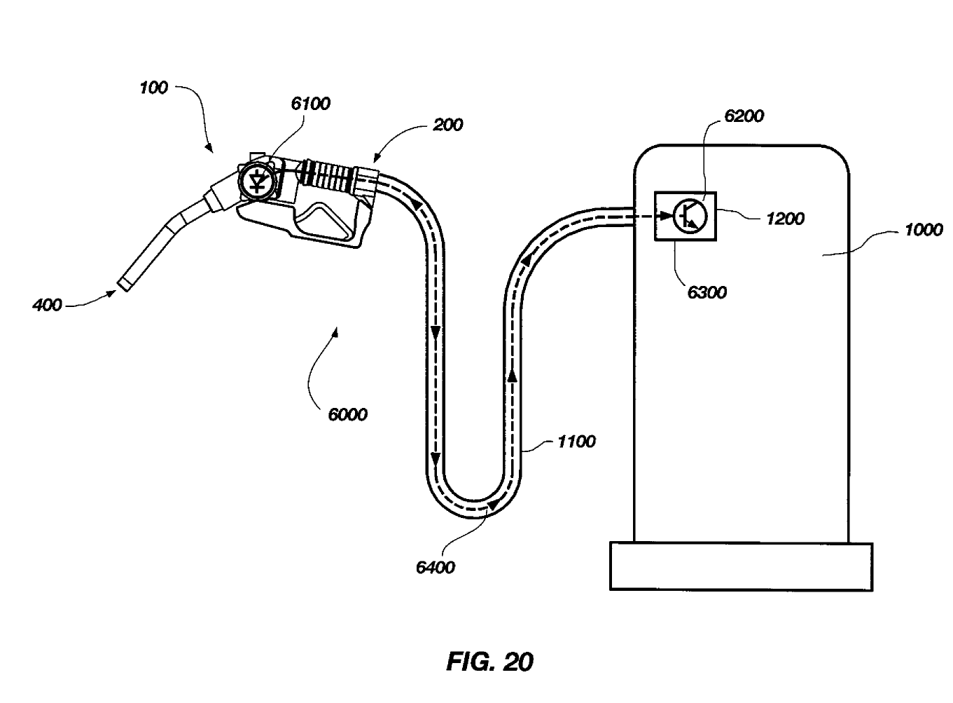

As shown in FIG. 20, according to one embodiment of the present invention, an infrared subassembly (such as, but not limited to, a light emitting diode—LED) 6000 may be configured to transmit a signal from the pressure sensor subassembly 600 using an infrared transmitter subassembly 6100. The pump subsystem 1100 may be configured with an infrared detector subassembly 6200 having a LED receiver board 6300 operably connected to the cutoff subassembly 1200. The cutoff subassembly may be configured to cease flow of liquid to the fuel valve assembly 100 when it receives a signal from the ultrasonic detector subassembly generated by the infrared transmitter subassembly and transmitted from the fuel valve assembly via a light path 6400 in the hose subassembly 1100.

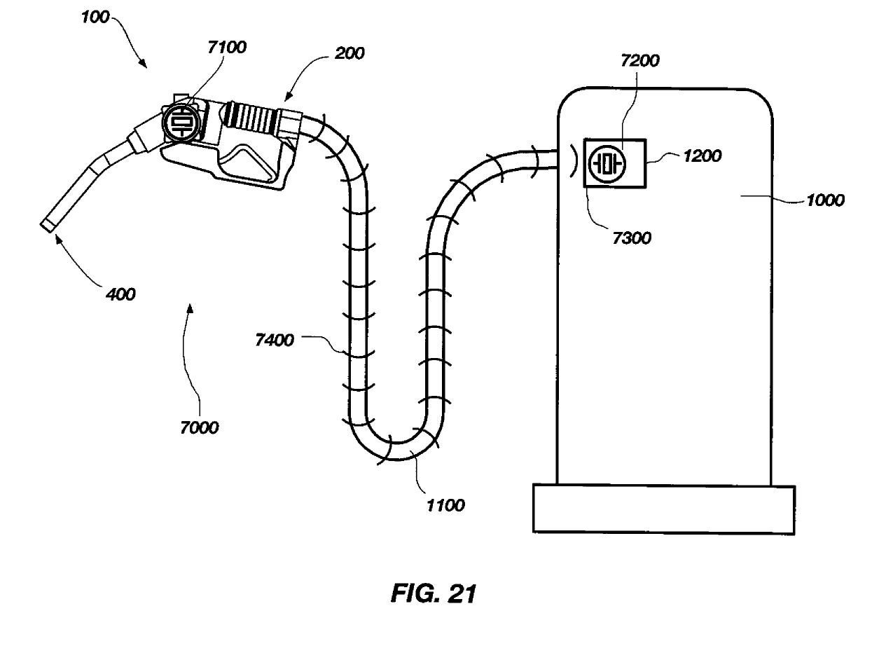

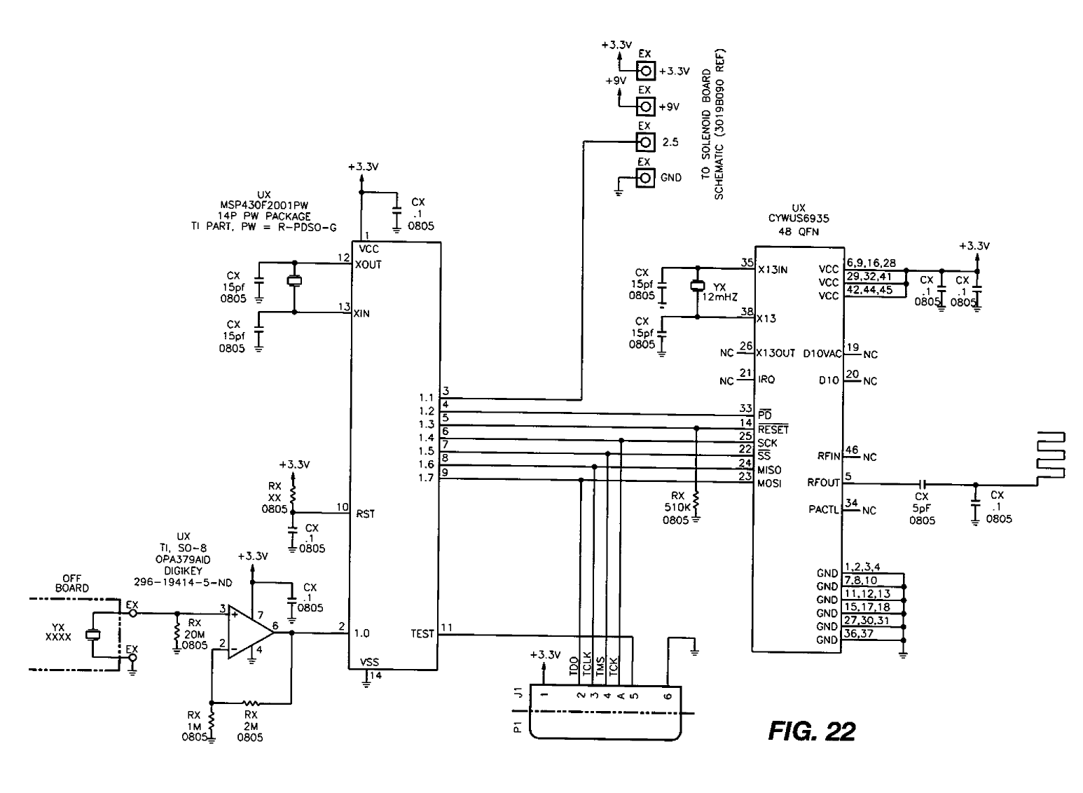

In one embodiment, as shown in FIG. 21, an ultrasonic subassembly 7000 may be configured to transmit a signal from the pressure sensor subassembly 600 using an ultrasonic transmitter subassembly 7100. The pump subsystem 1100 may be configured with an ultrasonic detector subassembly 7200 having an ultrasonic receiver board 7300 operably connected to the cutoff subassembly 1200. The cutoff subassembly may be configured to cease flow of liquid to the fuel valve assembly 100 when it receives a signal from the ultrasonic detector subassembly generated by the ultrasonic transmitter subassembly and transmitted from the fuel valve assembly via a sonar pulse path 7400 along the hose subassembly 1100. In an additional aspect, communication between the pump subsystem 1100 and the fuel valve assembly 100 may be accomplished by use of an appropriately configured fiber optic cable and associated transmitters and receivers.

In one aspect of the invention, signal transmission between the fuel valve assembly 100 and the pump subsystem 1000 may be configured for two-way communication. For example, a radio frequency transmitter subassembly 5100 and a sending antenna subassembly 5200 may be disposed on both the fuel valve assembly 100 (or other suitable portion of the main body subassembly 200) and the pump subsystem 1000. Likewise a receiving antenna subassembly 5300 may be disposed on both the pump subsystem 1000 and the fuel valve assembly 100. Advantageously, information regarding the operation of the fuel valve assembly 100 may be transmitted to the pump subsystem 1000. Additionally, information regarding the pump subsystem 1000 may be communicated to the fuel valve assembly 100. For example, when the power reserve on the battery 930, 950 falls below a predetermined level, a signal could be transmitted to the pump subsystem 1000 to shut down the pump or provide an indicator to service personnel that the fuel valve assembly requires servicing. In another aspect of the invention, a signal may be sent from the pump subsystem 1000 to the fuel valve assembly 100 seeking a confirmatory indication that electronics and/or other components of the fuel valve assembly 100 are operating properly. If a confirmatory signal is not received from the fuel valve assembly 100, a visual or auditory indicator may activated to notify service station personnel or other interested party that the fuel valve assembly requires service.

In another aspect, if a confirmatory signal is not received from the fuel valve assembly 100, the pump subsystem 1000 may actuate a pump shutdown sequence thereby terminating any fluid flow from the pump subsystem 1000. In an additional aspect, if a confirmatory signal is not received from the fuel valve assembly 100, the pump subsystem 1000 will not initiate any fueling sequence (i.e., without a signal indicating that the fuel valve assembly 100 is functioning properly, the pump subsystem 1000 will not pump fuel.) It is understood and contemplated herein that the confirmatory signal may be communicated to and from the fuel valve assembly 100, the pump subsystem 1000, and any other entity or computer system as desired (e.g., cell phone, web-based communication device, or other mobile device).

In an additional embodiment of the present invention, the fuel valve assembly 100 and/or the pump subsystem 1000, and related electrical components may be equipped with a watchdog circuit to minimize the hazards associated with electrical failure. In one aspect of the invention, the watchdog circuitry may incorporate structures and principles of operation as described in U.S. Pat. No. 5,627,867 which is incorporated herein by reference in its entirety. Advantageously, if the components within the main body subassembly 200 are not functioning properly (particularly components which relate to flow shut off within the main body subassembly) fuel flow from the pump subsystem 1000 may not be initiated by a motorist. In one aspect, the fuel valve assembly 100 will be biased in a closed position unless corresponding electrical components within the main body subassembly 200 are functioning properly. In another embodiment, a fail-safe switch may trigger the actuator subassembly 800 within the main body subassembly 200 if components within the main body subassembly 200 (e.g., low battery power, malfunctioning pressure sensor, malfunctioning solenoid, etc.) are not working properly. In this manner, the triggered actuator subassembly 800 precludes initiation of a fueling sequence.

In one aspect of the invention, a signal may be sent from the fuel valve assembly 100 to the pump subsystem 1000 indicating if the actuator subassembly 800 was activated by some stimulus other than the solenoid subassembly 700. As described further below, other means may be employed to activate the actuator subassembly 800 in combination with the solenoid subassembly 700 in an effort to ensure proper shut down of the fuel valve assembly 100. Advantageously, transmission of a signal if the actuator subassembly 800 is activated by some stimulus other than the solenoid subassembly 700 provides notice to service personnel when the actuator subassembly 800 or the solenoid subassembly 700 is malfunctioning.

In an additional aspect, when the fuel valve assembly 100 is removed from the cradle 1200 of the pump subsystem 1000, a signal could be transmitted to the pump subsystem indicating that a fueling sequence is about to begin. Advantageously, in one aspect of the invention, if the pressure sensor subassembly 600 is accidentally actuated during the beginning of the fueling sequence thereby precluding flow of gasoline from the pump subsystem 1000, a signal from the fuel valve assembly 100 could be sent to the pump system overriding the pump systems termination of fluid flow. This may be accomplished, for example, by sending a signal to the pump subsystem 1000 to ignore any signals related to pump subsystem shutdown for a sixty second interval after the initial fueling sequence begins. It is understood and contemplated herein, however, that any suitable time interval may be used as suits a particular application. In this manner, any initial accidental actuation from the pressure sensor subassembly 600 would not affect the pumping sequence. It is understood and contemplated herein that the signals sent to and from the pump subsystem 1000 or to and from the fuel valve assembly 100 could also be transmitted to a central server or any suitable computer module via a wireless internet connection or any other suitable means for remote communication.

In another embodiment of the invention, a tilt sensor (now shown) may be disposed within a portion of the main body subassembly 200 to detect the position of the main body subassembly with respect to the cradle 1200 and the gasoline tank fill tube. In this manner, a signal may be transmitted to the pump subsystem 1000 and/or the actuator subassembly 800 indicating when the main body subassembly 200 is in an upright position (e.g., docked with the cradle) or in a downward position (e.g., engaged in a fueling sequence). In one aspect, the tilt sensor comprises a mercury switch or a microelectromechanical system (MEMS) sensor configured to detect the position of the main body subassembly with respect to the cradle 1200 and the gasoline tank fill tube. It is understood, however, and contemplated herein that any suitable switch may be used as desired for a particular application. In one aspect of the invention, the electrical components incorporated within the main body subassembly 200 are protected via dipping or lacquered coatings or are otherwise compartmentalized within an explosion proof member to minimize risk of ignition of the fueling vapors.

In another embodiment of the present invention, the spring 850 of the solenoid subassembly 700 may be replaced with an additional solenoid assembly (not shown) for resetting the actuator subassembly 800. In this manner, when the solenoid 740 is tripped, rather than being reset automatically by spring 850, a reset switch would be engaged to activate the additional solenoid assembly (not shown) which would push the plunger 820 back into place. In like manner the plunger of the additional solenoid assembly would be reset by the triggering of the primary solenoid subassembly 700. In one aspect, the additional solenoid assembly could be activated upon receipt of signal from a tilt sensor (not shown) as discussed above. In this manner, a consumer would need to return the main body subassembly to an upright position to reset the solenoid subassembly 700. In an additional aspect, the additional solenoid assembly could be configured to reset once it is placed within the cradle 1200 of the pump subsystem 1000.

In another aspect of the invention, spring 850 is replaced with a ferromagnetic material configured to cause the actuator in the solenoid 740 to move in an extended or retracted position depending in the direction of the last pulse of current through the solenoid. The direction of the last pulse of current would coincide with signals received from sensors placed within the fuel valve assembly 100 indicating whether the solenoid subassembly 700 should be positioned in an open or closed configuration.

With reference now FIG. 25, in an additional embodiment, the liquid dispensing system described herein may be used in conjunction with other traditional and/or non-traditional mechanical devices for terminating fluid flow. For example, a complete liquid dispensing system may employ a plurality of flow shut down techniques including both the liquid dispensing system described herein and assemblies that, for example, comprise fluid shutdown devices which are actuated by a pressure differential on either side of a diaphragm 631. In one aspect, the diaphragm 631 is positioned between two chambers in the main body of the fuel valve assembly 100, wherein pressure in the gasoline tank fill tube is communicated from the nozzle tip via a venturi tube 460 connected to a chamber on one side of the diaphragm 631. In yet another aspect of the invention, the fuel valve sub assembly 100 may incorporate structures and principles of operation from a liquid dispensing system described in U.S. Pat. No. 5,645,115 which is incorporated herein by reference in its entirety.

In one aspect of the invention, the venturi tube 460 is operably connected to both the diaphragm 631 and the piezoelectric disk 630, such that a change in pressure in the gasoline fill tube could actuate the termination of fluid flow by the piezoelectric disk 630 and/or the diaphragm 631. In yet another embodiment, a venturi tube 460 may be connected to the diaphragm and a separate venturi tube may be connected to the piezoelectric disk 630. Advantageously, in one aspect of the invention, the sensitivity of the piezoelectric disk 630 may be adjusted to be less sensitive during the beginning of a fueling sequence to minimize false termination of fluid flow and may also be adjusted to be more sensitive after the initial fueling sequence has begun to ensure quick termination of fluid flow.

In one aspect of the invention, a service station operator and/or owner of a pump subsystem would not pay for the installation and maintenance of the fuel valve assembly 100 up front. Rather, a fee based on the amount of gasoline pumped through the fuel valve assembly could be charged to cover the costs of the product as well as service, maintenance, and replacement of the fuel valve assembly 100 and/or other related components of the pump subsystem 1000.

Further modifications and improvements may additionally be made to the liquid dispensing system, pump subsystem, fuel valve assembly and methods of use disclosed herein without departing from the scope of the present invention. Accordingly, it is not intended that the invention be limited by the embodiments disclosed herein.

We claim:

1. A liquid dispensing assembly, comprising:
a main body subassembly having a parts housing containing a valve;
a nozzle subassembly connected to the main body, the nozzle subassembly comprising a pressure sensor subassembly configured to reside with the parts housing, wherein the pressure sensor subassembly comprises a piezoelectric disk;
a solenoid subassembly electrically connected to the pressure sensor subassembly and a power source; and
an actuator subassembly connected to the solenoid subassembly and configured for closing the valve.

2. The liquid dispensing assembly of claim 1, wherein the pressure sensor subassembly further comprises a diaphragm operably connected to the actuator subassembly.

3. The liquid dispensing assembly of claim 2, wherein the nozzle subassembly includes an end tube having a venturi hole operably connected to a venturi tube.

4. The liquid dispensing assembly of claim 2, wherein the nozzle subassembly includes an end tube having a venturi hole operably connected to a venturi tube and wherein the venturi tube is operably connected to the piezoelectric disk and the diaphragm.

5. The liquid dispensing assembly of claim 1, further including a cover subassembly configured for retaining a power source.

6. The liquid dispensing assembly of claim 5, further comprising an audible or visual indicator configured to indicate when a power reserve of the power source drops below a predetermined level.

7. The liquid dispensing assembly of claim 1, further comprising a position sensor disposed on the nozzle subassembly, the position sensor configured to determine when a distal end of the nozzle subassembly has been inserted into a portion of a gas tank and further configured to determine when the distal end of the nozzle is moved within the portion of the gas tank.

8. The liquid dispensing assembly of claim 7, wherein the position sensor is configured to transmit a signal to the solenoid subassembly when the distal end of the nozzle is moved within the portion of the gas tank a predetermined distance.

9. The liquid dispensing assembly of claim 7, wherein the position sensor is configured to transmit a signal to a pump subsystem when the distal end of the nozzle is moved within the portion of the gas tank a predetermined distance.

10. The liquid dispensing assembly of claim 1, wherein the nozzle subassembly includes an end tube having a venturi hole operably connected to a venturi tube, wherein the venturi tube is operably connected to the piezoelectric disk and wherein the actuator subassembly is configured to interface with a poppet operably connected to the valve such that a change in pressure at the venturi hole causes the actuator to close the valve.

11. The liquid dispensing assembly of claim 1, further comprising a remote communication system configured to transmit and receive information to and from the nozzle subassembly and a pump subsystem, wherein the pump subsystem is configured to send a signal to the nozzle subassembly and terminate fluid flow from the pump subsystem if an appropriate signal is not received back from the nozzle subassembly.

12. The liquid dispensing assembly of claim 1, further including a pressure strip detection system disposed near an end tube of the nozzle subassembly and connected to the actuator subassembly.

13. A liquid dispensing system, comprising:
(a) a valve subsystem including.
(i) a main body subassembly having a parts housing containing a valve,
(ii) a nozzle subassembly connected to the main body and having an orifice with a venturi hole operably connected to a venturi tube,
(iii) a pressure sensor subassembly configured to reside with the parts housing operably connected to the venturi tube,
(iv) a solenoid subassembly electrically connected to the pressure sensor subassembly and a power source, and
(v) an actuator subassembly configured for closing the valve;
(b) a pump subsystem having a switching subassembly and a pump for delivering liquid to the valve subsystem; and
(c) an apparatus configured to operably connect the actuator subassembly of the valve subsystem to the switching subassembly of the pump subsystem, wherein the valve subsystem is configured to close the valve and the pump subsystem is configured to turn off the pump when the pressure sensor subassembly detects a pressure change at the venturi hole.

14. The liquid dispensing assembly of claim 13, further comprising a sensor configured to detect when a component of the main body subassembly is not functioning properly, said sensor being configured to transmit a signal to the pump subsystem indicating that a component of the main body subassembly is not functioning properly.

15. The liquid dispensing assembly of claim 13, further comprising a sensor disposed within the main body subassembly configured to detect when the main body subassembly is in an upright position.

16. The liquid dispensing assembly of claim 13, further comprising a sensor disposed within the main body subassembly configured to detect when internal components of the main body subassembly are not functioning properly.

17. The liquid dispensing assembly of claim 13, wherein the pump subsystem further comprises a receiving member configured to receive and secure the main body subassembly and further comprising a contact element disposed on the pump subsystem configured to detect when the main body subassembly is in contact with the receiving member.

18. A method for dispensing a liquid, comprising:
providing a valve subsystem including a valve, a pressure sensor subassembly operably connected to a solenoid subassembly, and an actuator subassembly configured for interfacing with the valve so as to close the valve when the solenoid is activated by the pressure sensor subassembly, wherein the pressure sensor subassembly comprises a piezoelectric disk;
providing a pump subsystem in fluid communication with the valve subsystem, the pump subsystem having a cutoff subassembly connected to a pump subassembly; and
connecting the actuator subassembly of the valve subsystem to the cutoff subassembly of the pump subsystem so that liquid from the pump subassembly ceases to flow to the valve subsystem after a predetermined period of time when the pressure sensor subassembly activates the solenoid subassembly.

19. The method of claim 18, further comprising transmitting a signal from the valve subsystem to the pump subsystem when an initial pumping sequence begins.

20. The method of claim 19, further comprising the step of transmitting a signal from the valve subsystem to the pump subsystem when the actuator subassembly is activated by an event other than stimulus from the solenoid subassembly.

21. A liquid dispensing assembly, comprising:
a main body subassembly having a parts housing containing a valve;
a nozzle subassembly connected to the main body, the nozzle subassembly comprising a pressure sensor subassembly configured to reside with the parts housing;
an actuator subassembly operably connected to the pressure sensor subassembly, said actuator subassembly configured for closing the valve; and
a position sensor disposed on the nozzle subassembly configured to detect when the nozzle subassembly is oriented in an upright position.

22. The liquid dispensing assembly of claim 21, further comprising a pump subsystem operably connected to main body subassembly, said pump subsystem configured to detect when components of the main body subassembly are not functioning properly and further configured to preclude fluid flow through the pump subsystem if components of the main body subassembly are not functioning properly.

23. A liquid dispensing assembly, comprising:
a main body subassembly having a parts housing containing a valve;
a nozzle subassembly connected to the main body, the nozzle subassembly comprising a pressure sensor subassembly configured to reside with the parts housing;
an actuator subassembly operably connected to the pressure sensor subassembly, said actuator subassembly configured for closing the valve; and
a position sensor disposed on the nozzle subassembly configured to detect when the nozzle subassembly is inserted within a portion of a gas tank, said sensor further configured to detect when the nozzle subassembly is moved a predetermined distance within the gas tank.

24. The liquid dispensing system of claim 23, further comprising a pump subsystem operably connected to the main body subassembly, said pump subsystem configured to preclude fluid flow to the main body subassembly when the nozzle subassembly is moved a predetermined distance within the gas tank after initial insertion within the gas tank.

25. The liquid dispensing system of claim 24, wherein said pump subsystem is further configured to transmit a signal to a remote location indicating when fluid flow from the pump subsystem is precluded.

26. A liquid dispensing assembly, comprising:
a main body subassembly having a parts housing containing a valve;
a nozzle subassembly connected to the main body, the nozzle subassembly comprising a pressure sensor subassembly configured to reside with the parts housing;
an actuator subassembly operably connected to the pressure sensor subassembly, said actuator subassembly configured for closing the valve; and
a pump subsystem operably connected to main body subassembly, said pump subsystem configured to detect when components of the main body subassembly are not functioning properly and further configured to preclude fluid flow through the pump subsystem if components of the main body subassembly are not functioning properly.

27. A liquid dispensing assembly, comprising:
a main body subassembly having a parts housing containing a valve;
a nozzle subassembly connected to the main body, the nozzle subassembly comprising a pressure sensor subassembly configured to reside within the parts housing;
an actuator subassembly operably connected to the pressure sensor subassembly, said actuator subassembly configured for closing the valve; and
a sensor disposed within the main body subassembly configured to detect when an electrical component within the main body subassembly is not functioning properly, said sensor configured to send a signal to the actuator subassembly to close the valve.

28. A liquid dispensing assembly, comprising:
a main body subassembly having a parts housing containing a valve, wherein said valve is biased in a closed position;
a nozzle subassembly connected to the main body, the nozzle subassembly comprising a pressure sensor subassembly configured to reside within the parts housing;
an actuator subassembly operably connected to the pressure sensor subassembly, said actuator subassembly configured for opening the valve; and
a sensor disposed within the main body subassembly configured to detect when an electrical component within the main body subassembly is functioning properly, said sensor configured to send a signal to the actuator subassembly to open the valve if the electrical components are functioning properly.
